(19) United States
(12) Patent Application Publication
(10) Pub. No.: US 2019/0012676 A1
(43) Pub. Date: Jan. 10, 2019

(54) SYSTEM AND METHOD FOR UTILIZING SECONDARY USER BIOMETRIC DATA FOR USER AUTHORIZATION

(71) Applicant: Mastercard Asia/Pacific Pte. Ltd., Singapore (SG)

(72) Inventors: Benjamin Charles Gilbey, Singapore (SG); Rajat Maheshwari, Singapore (SG); Philip Wei Ping Yen, Singapore (SG)

(21) Appl. No.: 16/021,396

(22) Filed: Jun. 28, 2018

(30) Foreign Application Priority Data
Jul. 7, 2017 (SG) 10201705618V

(51) Int. Cl. G06Q 20/40; G06Q 20/10; G06Q 20/20; G06Q 20/30

(52) U.S. Cl. CPC G06Q 20/40145; G06Q 20/30; G06Q 20/20; G06Q 20/102

(57) ABSTRACT

There is provided a system and method for utilizing secondary user biometric data for user authorization. Generally, in addition to the utilisation of primary user biometric data, the secondary user biometric data is also used to ensure that an additional level of authentication is carried out.

### CROSS-REFERENCE TO RELATED APPLICATION

This application is a U.S. National Stage filing under 35 U.S.C. § 119, based on and claiming benefits of and priority to Singapore Patent Application No. 10201705618V filed on Jul. 7, 2017. The entire disclosure of the above application is incorporated herein by reference for all purposes.

### FIELD OF THE INVENTION

The present invention relates to a system and method for utilizing secondary user biometric data for user authorization.

### BACKGROUND

Payment transactions are increasingly being carried out using mobile data processing devices such as, for example, smartphones, tablets, laptops and so forth, using a digital wallet application running on the mobile data processing devices. Sometimes, the mobile data processing devices are used in combination with point-of-sale (POS) devices to carry out the payment transactions. The digital wallet application is associated with at least one payment card such as a credit, debit or gift card, and correspondingly, is able to provide a financial account linked to the card in order to effect payment for the goods or services. Biometric authentication is increasingly being used by mobile device users to authorize the payment transactions carried out using the mobile data processing devices.

Currently, open mobile device operating systems like Android™ provide a framework for biometrics authentication with no restrictions on False Acceptance Rate/False Rejection Rate or a minimum expected matching score. In this regard, biometrics authentication on mobile devices can be easily circumvented due to the lack of the aforementioned restrictions. Generally, users have little or no insight in relation to how each mobile device manufacturer enables biometric authentication on their mobile devices. This is because mobile device manufacturers do not disclose implementation details or algorithms used for their biometric authentication capabilities on their mobile devices.

The potential for unauthorized payment transactions being carried out using mobile devices are a concern to both users and issuers. Such risks are typically undesirable for the user as a financial liability for the user may be substantial, and for the issuer, there may be costly fraudulent transactions.

It is desirable to minimise the incidence of unauthorized payment transactions using mobile devices especially since the biometric authentication capabilities of the mobile devices are questionable. It is against this background, and the problems and difficulties associated therewith, that the present invention has been developed.

### SUMMARY

In a first aspect, there is provided a system for utilizing secondary user biometric data for user authorization, the system including one or more electronic devices that:
initiate, at a user payment device, a transaction request using primary user biometric information;
activate, at the user payment device, at least one sensor to capture secondary user biometric information;
generate, at the user payment device, at least one template from the secondary user biometric information;
transmit, to a biometric authorization system, the at least one template for verification;
request, from the user payment device and/or a payment acceptance device, user account information;
generate, from the user payment device or payment acceptance device, a transaction request message including the user account information; and
initiate, at a payment processing system, a payment authorization request using the transaction request message and a positive verification of the at least one template.

In a second aspect, there is provided a method for utilizing secondary user biometric data for user authentication, the method including, in one or more electronic processing devices:
initiating, at a user payment device, a transaction request using primary user biometric information;
activating, at the user payment device, at least one sensor to capture secondary user biometric information;
generating, at the user payment device, at least one template from the secondary user biometric information;
transmitting, to a biometric authorization system, the at least one template for verification;
requesting, from the user payment device and/or a payment acceptance device, user account information;
generating, from the user payment device or payment acceptance device, a transaction request message including the user account information; and
initiating, at a payment processing system, a payment authorization request using the transaction request message and a positive verification of the at least one template.

In a third aspect, there is provided a user payment device for utilizing secondary user biometric data for user authentication, the device including one or more electronic devices:
that: initiate, a transaction request using a primary user biometric information; activate, at least one sensor to capture secondary user biometric information;
generate, at least one template extracted from the secondary user biometric information; transmit, to a biometric authorization system, the at least one template for verification;
provide, user account information; and generate, a transaction request message including the user account information and the user biometric information.

In a final aspect, there is provided a non-transitory computer readable storage medium embodying thereon a program of computer readable instructions which, when executed by one or more processors of a user payment device in communication with at least one other server, cause the user payment device to carry out a method for utilizing secondary user biometric data for user authentication, the method embodying the steps of:
initiating, a transaction request using a primary user biometric information;
activating, at least one sensor to capture secondary user biometric information;
generating, at least one template extracted from the secondary user biometric information; transmitting, to a biometric authorization system, the at least one template for verification; providing, user account information; and generating, a transaction request message including the user account information.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

A non-limiting example of the present invention will now be described with reference to the accompanying drawings, in which: —

FIG. 1 is a flow chart of an example of a method of utilizing secondary biometric data for user authorization;

FIG. 2 is a schematic diagram of an example of a system of utilizing secondary biometric data for user authorization;

FIG. 3 is a schematic diagram showing components of an example point-of-sale (POS) device of the system shown in FIG. 2;

FIG. 4 is a schematic diagram showing components of an example user device of the system shown in FIG. 2;

FIG. 5 is a schematic diagram showing components of an example server shown in FIG. 2;

FIG. 6 is a schematic diagram showing components of an example payment system shown in FIG. 2; and

FIGS. 7A, 7B and 7C are flowcharts of a specific example of a method of utilizing secondary biometric data for user authorization.

### DETAILED DESCRIPTION

Embodiments of the present invention provide users with a convenient way to utilise secondary user biometric information for user authentication. Advantageously, an additional level of authentication can be provided without additional effort/intervention from the user. Furthermore, at least some embodiments of the present invention can be carried out without any substantial modification to the hardware of existing user payment devices. Use of the additional level of authentication can be dependent on a transaction amount. For example, the additional level of authentication can be removed if the transaction amount is below a predefined amount.

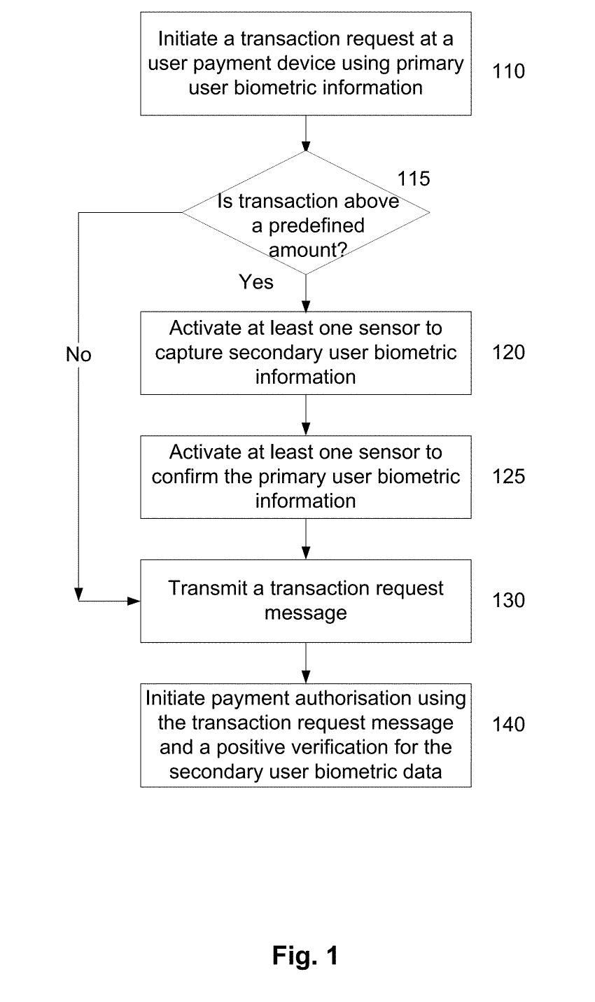

An example of a method of utilizing secondary biometric information in a payment transaction will now be described with reference to FIG. 1.

For the purpose of illustration, it is assumed that the method can be performed at least in part using one or more electronic processing devices which form part of a point-of-sale (POS) device, in communication with one or more user devices, such as mobile phones, portable computers, tablet computers, wearable devices, or the like. The POS device is typically also in communication with a payment processing system which may include a number of processing devices associated with each of an issuer, acquirer, card network and payment gateway, or alternatively, the payment processing system may be any one or more of these entities and this will be discussed further below.

In this example, at step 110, the one or more electronic processing devices initiate a transaction request at a user payment device using primary user biometric information in a digital wallet application or merchant application installed on the user payment device, such as, for example, MasterPass™, Apple™ Pay, Google™ Wallet, or the like, and in some instances the application is provided by a user's banking institution. The user payment device can be, for example, a mobile phone, a portable computer, a tablet computer, a wearable device, or the like. The primary user biometric information can include, for example, fingerprint data, iris data, facial features data, pulse rate data, voice data, retina data, ear cavity echo data, vein pattern data, speech pattern data and so forth. The primary user biometric information can be obtained using appropriate sensors such as, for example, an image capture device, a voice capture device, a fingerprint reader, a microphone, a heart-rate monitor, and so forth.

At step 115, the one or more electronic processing devices determine if a transaction amount for the transaction request is above a predefined amount, for example, $100. The predefined amount can be set by a user in the digital wallet application or merchant application installed on the user payment device. The predefined amount can also be defined by the user's banking institution (provider of the user's payment card) or a merchant (provider of the merchant application). If the transaction amount is less than the predefined amount, secondary biometric information is not utilised to authenticate the user, and the method proceeds to step 130 as described below.

If the transaction amount is above the predefined amount, at step 120, without intervention from the user, at least one biometric sensor of the user payment device is automatically activated to capture secondary user biometric information. The secondary user biometric information can include, for example, fingerprint data, iris data, facial features data, pulse rate data, voice data, retina data, ear cavity echo data, vein pattern data, speech pattern data and so forth. The secondary user biometric information can be obtained using appropriate sensors such as, for example, an image capture device, a voice capture device, a fingerprint reader, a microphone, a heart-rate monitor, and so forth. The secondary user biometric information may be different from the primary user biometric information to make it more difficult for fraudsters to circumvent the user authentication process.

At least one template is extracted from the secondary user biometric information and the at least one template is transmitted to a biometric authentication system for verification. The biometric authentication system can be an issuer server or a third party verification server. The one or more electronic processing devices then requests user account information from the user payment device. The request for account information can be provided in any suitable manner.

For example, if the user has a digital wallet application installed on the user payment device, the POS device may send a pull message to the user payment device requesting access to the digital wallet application which stores user account details such as credit card information and the like. Whilst any type of wallet application may be used, such as MasterPass™, Apple™ Pay, Google™ Wallet, or the like, in some instances the application is provided by a user's banking institution. The payment acceptance device receives payment credentials (such as a primary account number (PAN) or a token representative of a PAN) from the user payment device in order to transmit those credentials, together with other transaction-related information, to a payment network for processing. The payment acceptance device can be, for example, a card acceptance device such as a POS device. The POS device may be capable of accepting payment credentials in contactless fashion, for example from a mobile device according to the EMV Contactless Specification, or from a mobile device in a contactless magnetic stripe transaction by magnetic secure transmission (MST) technology.

In some embodiments, at step 125, upon prompting from the digital wallet application or merchant application (also known as a negotiation process), at least one biometric sensor of the user payment device is activated to recapture and process the primary user biometric information to confirm an identity of the user. This step can be included to provide the user with an additional layer of authentication, and is optional.

Subsequently, at step 130, the one or more electronic processing devices transmit a transaction request message, the transaction request message including the user account information. The transaction request message can be an ISO 8583 formatted message when the transaction request message is an EMV transaction request message or can be encoded in track data when the transaction request message is a contactless magnetic stripe transaction request message.

In one example, the user may allow the POS device access to the account information stored in their digital wallet application by authenticating the request with appropriate verification information such as a PIN number or biometric information associated with the digital wallet application. If instead the user has been prompted to supply account information via a payment page or the like displayed on their device, then the POS device may receive the user account information as a result of the user manually entering their bank account or card details in the payment UI. In a further example, the user device is configured to capture the primary and secondary user biometric information with requisite sensors of the user payment device.

After receiving the transaction request message and a positive verification for the secondary user biometric information, at step 140 the one or more electronic processing devices initiate payment authorization with a payment processing system, using the transaction request message and the positive verification of the secondary user biometric data to enable the payment transaction to be performed. As previously mentioned, the payment processing system may include a number of processing systems associated with each of an issuer, acquirer, card network.

In one example as will be well understood in the art, the payment acceptance device sends a transaction request message comprising the user account information to a merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

The abovementioned example therefore provides a method of utilizing secondary user biometric data for user authorization. The transaction is facilitated by one or more processing devices, which optionally form part of a physically distinct POS device, which may be separate to a POS terminal. The POS device can provide the necessary connectivity to allow interaction with a user payment device and other systems as required, allowing users to perform transactions using their own user payment device. The transaction can also be facilitated by one or more processing devices, which form part of a user payment device.

Accordingly, the above described method provides a number of advantages.

The present invention provides for the use of secondary user biometric data to aid in the authorization of the user, particularly for instances when transaction amounts are above a predefined amount. The present invention provides an additional level of authentication without additional effort/intervention from the user. Furthermore, the present can be carried out without any substantial modification to the hardware of existing user payment devices and the use of the secondary user biometric data can also aid in fraud detection/prevention. This may help to reduce network traffic since there is a reduced rate of additional authorization requests required following fraud detection.

A number of further features will now be described.

In order to further enhance security, communication with the user payment device may be encrypted. In one example, the digital wallet application installed on the user payment device may have embedded encryption that can only be decrypted by the payment acceptance device. In this way, user account information received by the payment acceptance device may be routed securely over the network and interpreted only by the payment acceptance device for use in initiating payment authorization with the payment processing system. In another example, the at least one template transmitted from the user payment device to the biometric authentication system can only be decrypted by the biometric authentication system.

In one example, the one or more electronic processing devices may send a request to the user payment device to access a digital wallet application installed on the user device in order to retrieve user account information, the user device being responsive to the request to selectively provide user account information to the one or more electronic processing devices. The electronic processing devices may then receive user account information from the user payment device. Typically, the digital wallet application is configured to verify the user, possibly using biometric information, to selectively provide the user account information.

In this regard, the digital wallet application may prompt the user to provide verification information, selectively authenticate the user using the verification information and provide access to the user account information in response to successful verification. Typically, the verification information includes a PIN number associated with the digital wallet application, however any form of verification information may be used including biometric information such as fingerprint data, iris data, facial features data, pulse rate data, voice data, retina data, ear cavity echo data, vein pattern data and speech pattern data. The user provides their PIN number to the digital wallet application which verifies the PIN typically at a remote server where the user security details are stored. If the PIN is verified as correct, the user is authenticated as being the owner of the digital wallet application and in response the digital wallet application provides the user account details to the POS device so that the payment authorization process can be initiated.

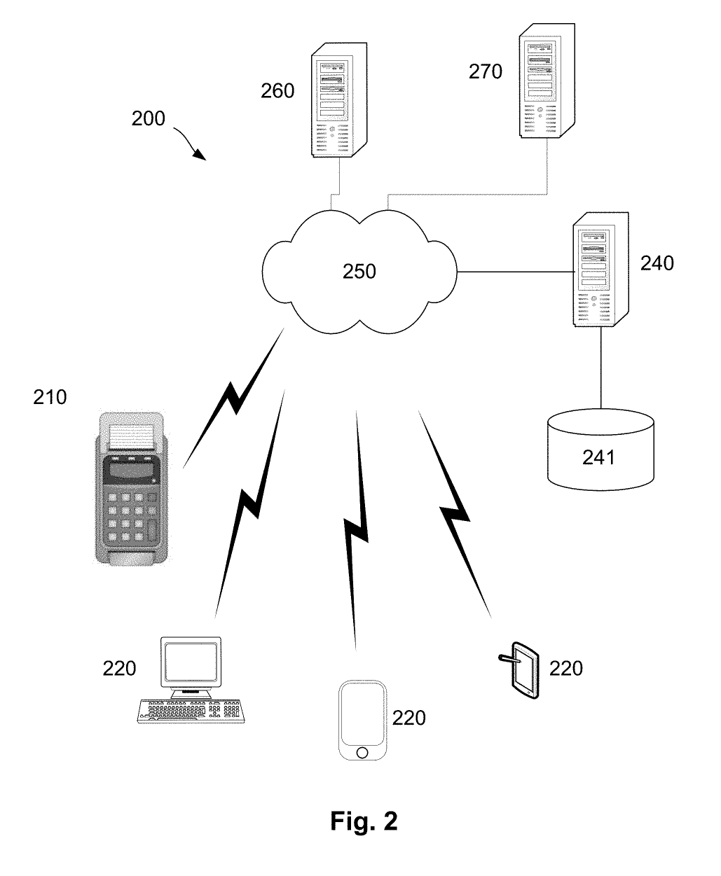

An example of a system for utilizing secondary user biometric data for user authentication will now be described with reference to FIG. 2.

In this example, the system 200 includes a POS electronic processing device 210, one or more user payment devices 220 running a payment application such as a digital wallet application and optionally a merchant application, a communications network 250, an biometric authentication system 260, an acquirer server 270 and a payment processing device 240 in communication with a database 241.

The communications network 250 can be of any appropriate form, such as the Internet and/or a number of local area networks (LANs) It will be appreciated that the configuration shown in FIG. 2 is for the purpose of example only, and in practice the user payment devices 220, POS device 210, biometric authentication system 260, acquirer server 270 and payment processing device 240 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like. Typically, the one or more user payment devices 220 can communicate with the POS device 210 via a wireless communication protocol such as Wi-Fi or Bluetooth but not limited to such. In one example, the POS device 210 includes a wireless router and provides a wireless network (e.g. Wi-Fi) to which the one or more user payment devices 220 are able to connect. Alternatively, the POS device 210 may be connected to a wireless network provided by a merchant to which the one or more user payment devices 220 may connect in order to communicate with the POS device 210.

POS Device 210

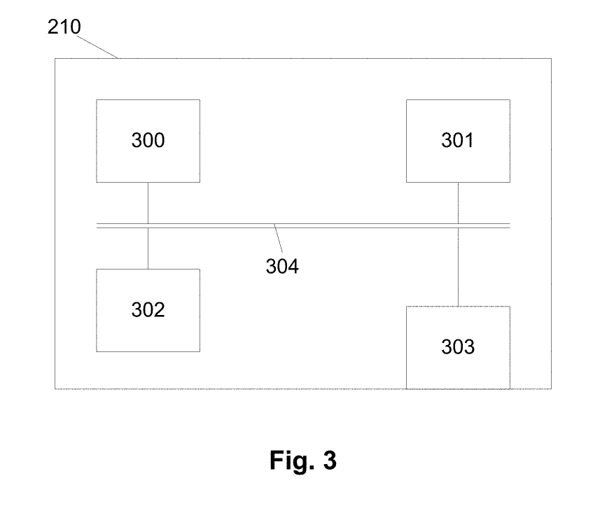

A suitable POS device 210 for use in the system for performing a POS payment transaction described in any of the above examples is shown in FIG. 3.

In this example, the POS device 210 includes at least one microprocessor 300, a memory 301, an optional input/output device 302, such as a display, keyboard, touchscreen and the like, and an external interface 303, interconnected via a bus 304 as shown. In this example the external interface 303 can be utilised by the POS device 210 when communicating with peripheral devices, such as the user payment device 220, communications networks, payment processing device 240, merchant server 230, biometric authentication system 260, acquirer server 270, databases, other storage devices, or the like. Although only a single interface 303 is shown, this is for the purpose of example only, and in practice multiple interfaces using various methods (e.g. Ethernet, serial, USB, wireless, Bluetooth™ Low Energy (BLE), Near Field Communication (NFC), or the like) may be provided.

In use, the microprocessor 300 executes instructions in the form of applications software stored in the memory 301 to allow communication with the user payment device 220, for example to receive a transaction request, the merchant processing device 240, for example to receive payment information, the biometric authentication system 260, for example to receive authorization information and the payment processing device 230, for example to initiate payment authorization. The applications software may include one or more software modules, and may be executed in a suitable execution environment, such as an operating system environment, or the like.

Accordingly, it will be appreciated that the POS device 210 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. However, the POS device 210 may also be formed from a suitably programmed PC, Internet terminal, lap-top, or hand-held PC, a tablet, or smart phone, or the like. Thus, in one example, the processing system 210 is a standard processing system such as an Intel Architecture based processing system, which executes software applications stored on non-volatile (e.g., hard disk) storage, although this is not essential.

User Payment Device 220

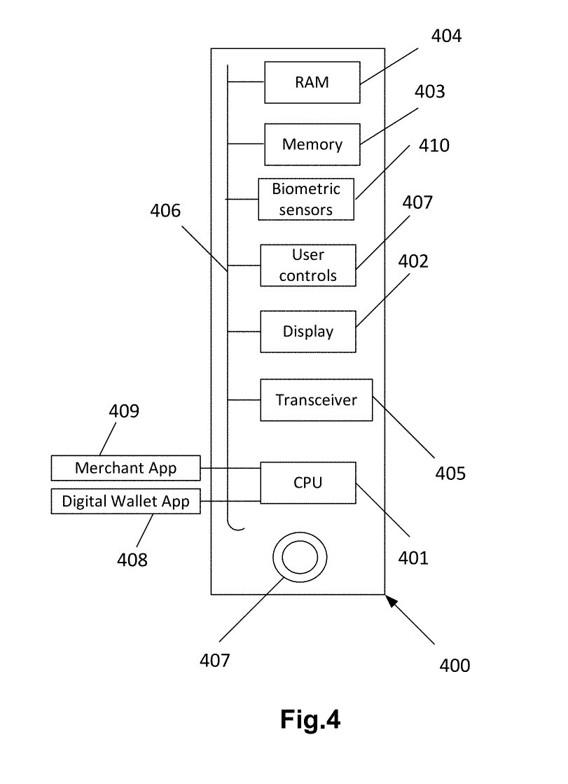

The user payment device 220 of any of the examples herein may be a handheld computer device such as a smart phone or a PDA such as one manufactured by Apple™, LG™, HTC™, Research In Motion™, Samsung™ or Motorola™. The user device 220 may include a mobile computer such as a tablet computer. Furthermore, the user device 220 may also include a wearable device like a smartwatch. An exemplary embodiment of a user payment device 400 is shown in FIG. 4. As shown, the device 400 includes the following components in electronic communication via a bus 406:
1. a display 402;
2. non-volatile memory 403;
3. random access memory (“RAM”) 404;
4. N processing components 401;
5. a transceiver component 405 that includes N transceivers;
6. biometric sensors 410; and
7. user controls 407.

Although the components depicted in FIG. 4 represent physical components, FIG. 4 is not intended to be a hardware diagram; thus many of the components depicted in FIG. 4 may be realized by common constructs or distributed among additional physical components. Moreover, it is certainly contemplated that other existing and yet-to-be developed physical components and architectures may be utilized to implement the functional components described with reference to FIG. 4.

The display 402 generally operates to provide a presentation of content to a user, and may be realized by any of a variety of displays (e.g., CRT, LCD, HDMI, micro-projector and OLED displays). And in general, the non-volatile memory 403 functions to store (e.g., persistently store) data and executable code including code that is associated with the functional components of a browser component and applications, and in one example, the payment application (digital wallet application) 408 and optionally a merchant application 409. In some embodiments, for example, the non-volatile memory 403 includes bootloader code, modem software, operating system code, file system code, and code to facilitate the implementation of one or more portions of the payment application 408 as well as other components well known to those of ordinary skill in the art that are not depicted for simplicity.

In many implementations, the non-volatile memory 403 is realized by flash memory (e.g., NAND or ONENAND memory), but it is certainly contemplated that other memory types may be utilized as well. Although it may be possible to execute the code from the non-volatile memory 403, the executable code in the non-volatile memory 603 is typically loaded into RAM 404 and executed by one or more of the N processing components 401.

The N processing components 401 in connection with RAM 404 generally operate to execute the instructions stored in non-volatile memory 403 to effectuate the functional components. As one of ordinarily skill in the art will appreciate, the N processing components 401 may include a video processor, modem processor, DSP, graphics processing unit (GPU), and other processing components.

The transceiver component 405 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The biometric sensors 410 include, for example, image capturing devices and microphones, whereby the biometric sensors 410 are configured to capture biometric information such as, for example, fingerprint data, iris data, facial features data, pulse rate data, voice data, retina data, ear cavity echo data, vein pattern data, speech pattern data and the like. The biometric sensors 410 can be integrated together or separate components. It should be appreciated that any one of the biometric sensors may be activatable on-demand by the payment application 408 and/or the merchant application 409.

Biometric Authentication System 260 and Acquirer Server 270

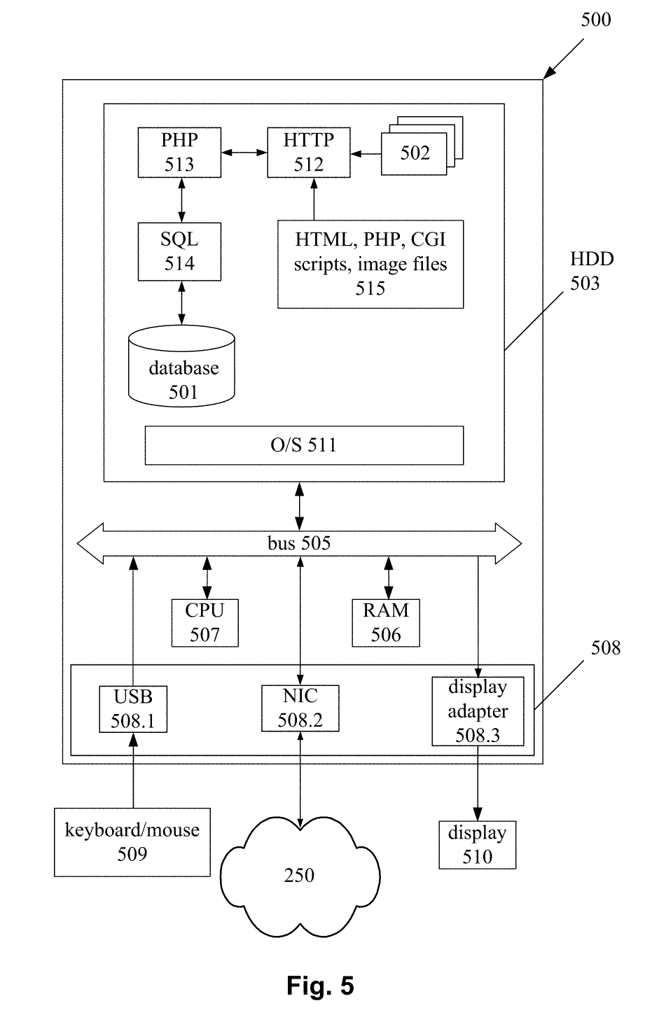

The biometric authentication system 260 and the acquirer server 270 of any of the examples herein may be formed of any suitable processing device, and one such suitable device is shown in FIG. 5.

In this example, a processing device is provided by a server 500 in communication with a database 501, as shown in FIG. 5. The computer system 500 is able to communicate with the POS device 210, user payment device 220, the payment processing device 240, and/or other processing devices, as required, over a communications network 550 using standard communication protocols.

The components of the processing system 500 can be configured in a variety of ways. The components can be implemented entirely by software to be executed on standard computer server hardware, which may comprise one hardware unit or different computer hardware units distributed over various locations, some of which may require the communications network 550 for communication. A number of the components or parts thereof may also be implemented by application specific integrated circuits (ASICs) or field programmable gate arrays.

In the example shown in FIG. 5, the processing system 500 is a commercially available server computer system based on a 32 bit or a 54 bit Intel architecture, and the processes and/or methods executed or performed by the computer system 500 are implemented in the form of programming instructions of one or more software components or modules 502 stored on non-volatile (e.g., hard disk) computer-readable storage 503 associated with the computer system 500. At least parts of the software modules 502 could alternatively be implemented as one or more dedicated hardware components, such as application-specific integrated circuits (ASICs) and/or field programmable gate arrays (FPGAs).

The computer system 500 includes at least one or more of the following standard, commercially available, computer components, all interconnected by a bus 505:
1. random access memory (RAM) 506;
2. at least one computer processor 507, and
3. external computer interfaces 508:
   a. universal serial bus (USB) interfaces 508.1 (at least one of which is connected to one or more user-interface devices, such as a keyboard, a pointing device (e.g., a mouse 509 or touchpad),
   b. a network interface connector (NIC) 808.2 which connects the computer system 500 to a data communications network, such as the Internet 550; and
   c. a display adapter 508.3, which is connected to a display device 510 such as a liquid-crystal display (LCD) panel device.

The computer system 500 includes a plurality of standard software modules, including:
1. an operating system (OS) 511 (e.g., Linux or Microsoft Windows);
2. web server software 512 (e.g., Apache, available at http://www.apache.org);
3. scripting language modules 513 (e.g., personal home page or PHP, available at http://www.php.net, or Microsoft ASP); and
4. structured query language (SQL) modules 514 (e.g., MySQL, available from http://www.mysql.com), which allow data to be stored in and retrieved/accessed from an SQL database.

Together, the web server 512, scripting language 513, and SQL modules 514 provide the computer system 500 with the general ability to allow users of the Internet 550 with standard computing devices equipped with standard web browser software to access the computer system 500 and in particular to provide data to and receive data from the database 501. It will be understood by those skilled in the art that the specific functionality provided by the system 500 to such users is provided by scripts accessible by the web server 512, including the one or more software modules 502 implementing the processes performed by the computer system 500, and also any other scripts and supporting data 515, including markup language (e.g., HTML, XML) scripts, PHP (or ASP), and/or CGI scripts, image files, style sheets, and the like.

The boundaries between the modules and components in the software modules 502 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the steps of the processes performed by the computer system 500 may be executed by a module (of software modules 502) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The computer system 500 normally processes information according to a program (a list of internally stored instructions such as a particular application program and/or an operating system) and produces resultant output information via input/output (I/O) devices 508. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

It should be appreciated that the biometric authentication system 260 can be either an issuer server or a third party verification server.

Payment System 240

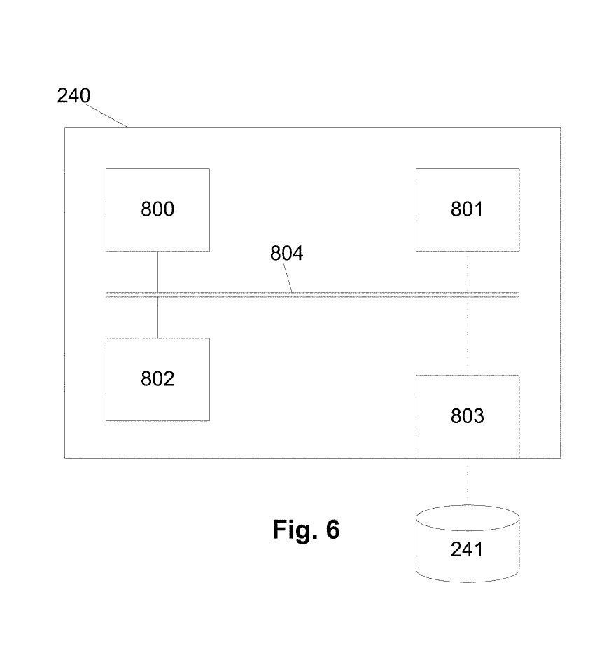

A suitable payment system 240 for use in the system described in any of the above examples is shown in FIG. 6.

In this example, the payment system 240 is a server (though in practice, the system 240 will comprise multiple such servers) that includes at least one microprocessor 800, a memory 801, an optional input/output device 802, such as a display, keyboard, touchscreen and the like, and an external interface 803, interconnected via a bus 804 as shown. In this example the external interface 803 can be utilised for connecting the payment server 240 to peripheral devices, such as the biometric authentication system 260, the acquirer server 270, the communication networks 250, databases 241, other storage devices, or the like. Although a single external interface 803 is shown, this is for the purpose of example only, and in practice multiple interfaces using various methods (e.g. Ethernet, serial, USB, wireless or the like) may be provided.

In use, the microprocessor 800 executes instructions in the form of applications software stored in the memory 801 to allow communication with the primary service provider server 240, for example to process payment required at the primary service provider server 240. The applications software may include one or more software modules, and may be executed in a suitable execution environment, such as an operating system environment, or the like.

Accordingly, it will be appreciated that the payment system 240 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. Thus, in one example, the processing system is a standard processing system such as an Intel Architecture based processing system, which executes software applications stored on non-volatile (e.g., hard disk) storage, although this is not essential.

In other examples, such as described above, the payment system is formed of multiple computer systems interacting, for example, via a distributed network arrangement. As distributed networking is known in the art, it will not be described further in more detail.

In particular, the payment system may include or be in communication with a number of processing systems associated with each of an issuer, acquirer, card network and payment gateway, or alternatively, the payment system may be any one or more of these entities.

In one example, the payment system sends the user account information and payment information to the merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer (in subsequent settlement and clearance processes as known in the art) who then deposits the payment into the merchant's account.

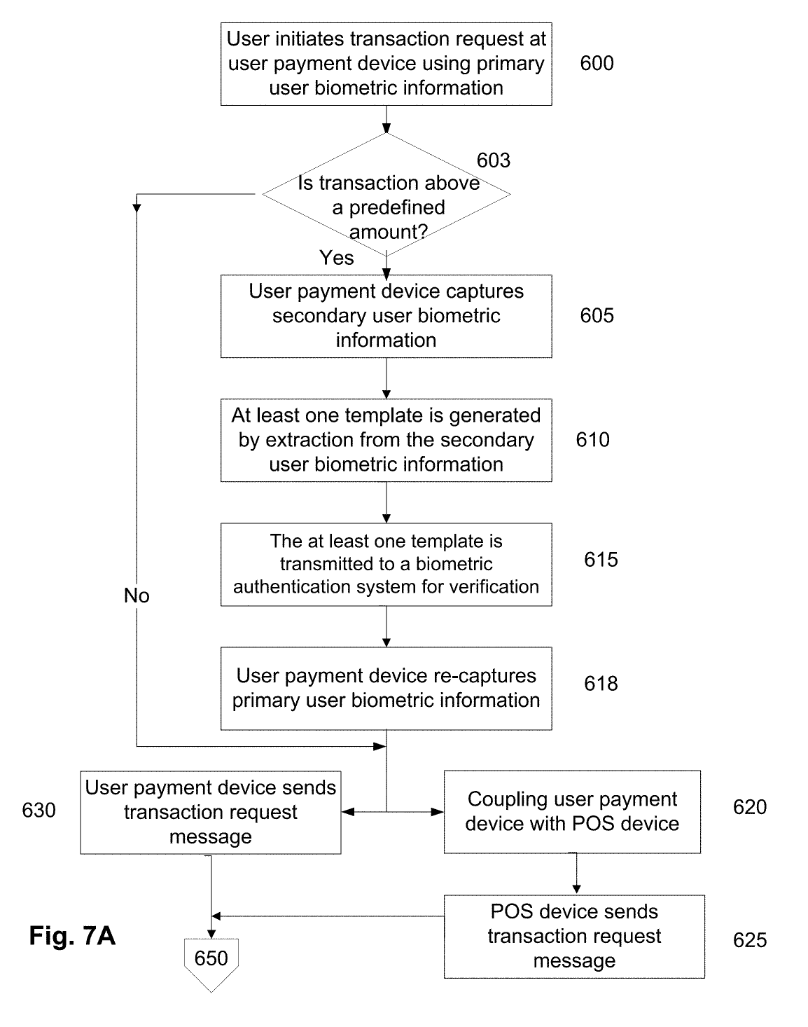

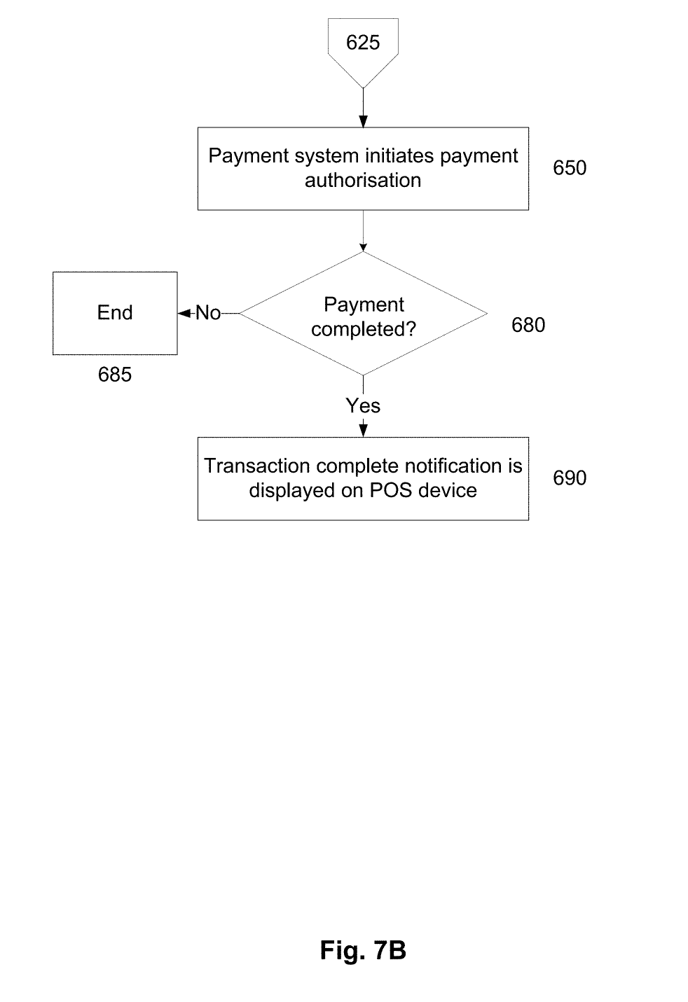

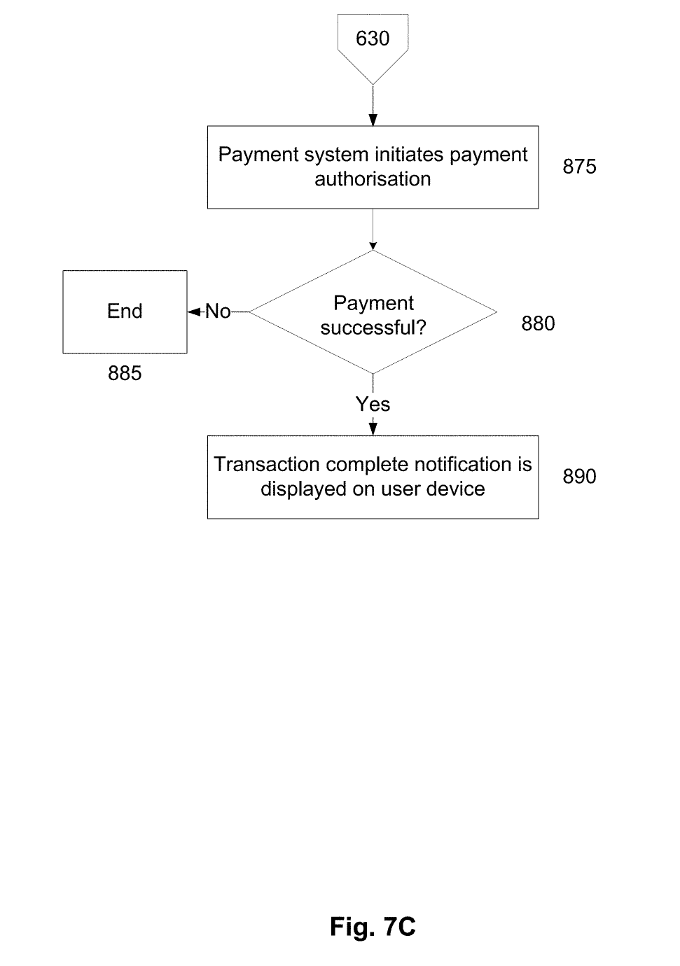

To illustrate further features of preferred practical implementations of the method, a first detailed example of a method of utilizing secondary user biometric data to authorize users will now be described with reference to FIGS. 7A-7C.

At step 600, a user initiates a transaction request at a user payment device using a primary user biometric information in a digital wallet application or a merchant application installed on the user payment device, such as, for example, MasterPass™, Apple™ Pay, Google™ Wallet, or the like, and in some instances the application is provided by a user's banking institution. The user can be at a remote location or at a merchant location in order to perform a transaction involving the purchase of goods and/or services provided by the merchant. The merchant location may take any suitable form and may include for example a store or retail outlet, restaurant, bar or café or a train or bus station. The merchant location may be any location where a POS transaction is performed between a consumer and a merchant. The user payment device can be, for example, mobile phones, portable computers, tablet computers, wearable devices, or the like. The primary user biometric information can include, for example, fingerprint data, iris data, facial features data, pulse rate data, voice data, retina data, ear cavity echo data, vein pattern data, speech pattern data and so forth. The primary user biometric information can be obtained using appropriate sensors such as, for example, an image capture device, a voice capture device, a fingerprint reader, a microphone, a heart-rate monitor, and so forth.

At step 603, it is determined if a transaction amount for the transaction request is above a predefined amount, for example, $100. The predefined amount can be set by a user in the digital wallet application or merchant application installed on the user payment device. The predefined amount can also be defined by the user's banking institution (provider of the user's payment card) or a merchant (provider of the merchant application). If the transaction amount is less than the predefined amount, secondary biometric information is not utilised to authenticate the user, and the method proceeds to step 620/630 as described below.

If the transaction amount is above the predefined amount, at step 605, without intervention from the user, at least one biometric sensor of the user payment device is simultaneously activated to capture a secondary user biometric information. The secondary user biometric information can include, for example, fingerprint data, iris data, facial features data, pulse rate data, voice data, retina data, ear cavity echo data, vein pattern data, speech pattern data and so forth. The secondary user biometric information can be obtained using appropriate sensors such as, for example, an image capture device, a voice capture device, a fingerprint reader, a microphone, a heart-rate monitor, and so forth. The secondary user biometric information may be different from the primary user biometric information to make it more difficult for fraudsters to circumvent the user authentication process.

At step 610, at least one template is extracted from the secondary user biometric information at the user payment device and subsequently, the at least one template is transmitted to an biometric authentication system for verification at step 615. A positive verification occurs when the at least one template substantially matches stored biometric information of the user at the biometric authentication system.

In some embodiments, at step 618, upon prompting from the digital wallet application or merchant application (also known as a negotiation process), at least one biometric sensor of the user payment device is activated to recapture and process the primary user biometric information to confirm an identity of the user. This step can be included to provide the user with an additional layer of authentication, and can be optional.

User At Merchant Location

In an instance when the user is at the merchant location, at step 620, the user payment device is coupled to a POS electronic processing device provided at the merchant location. Coupling can also be taken to mean pairing in appropriate circumstances. As previously described, any other suitable protocol (physical connection or wireless) may be used which allows communication between the POS device and the user payment device. Typically, the user will be able to connect or pair their user payment device (such as a mobile phone, laptop, tablet, smartwatch etc.) to the POS device from anywhere within the premises at the merchant location, though in general, near-field communications (NFC) is preferred since it is more secure than longer-distance RF-based communications. In any event, it will also be appreciated from this that this step could occur before the transaction is performed, and reference to the particular order of steps is not intended to be limiting.

At step 625, the POS device then sends a transaction request message including user account information to the payment processing system. For example, if the user has a digital wallet application installed on the user payment device, the POS device may send a pull message to the user payment device requesting access to the digital wallet application which stores user account details such as credit card information and the like. In one example, the user may allow the POS device access to the account information stored in their digital wallet application by authenticating the request with appropriate verification information such as a PIN number or biometric information associated with the digital wallet application. If instead the user has been prompted to supply account information via a payment page or the like displayed on their device, then the POS device may receive the user account information as a result of the user manually entering their bank account or card details in the payment UI.

Whilst any type of wallet application may be used, such as MasterPass™, Apple™ Pay, Google™ Wallet, or the like, in some instances the application is provided by a user's banking institution. The payment acceptance device receives payment credentials (such as a primary account number (PAN) or a token representative of a PAN) from the user payment device in order to transmit those credentials, together with other transaction-related information, to a payment network for processing. The payment acceptance device can be, for example, a card acceptance device such as a POS device. The POS device may be capable of accepting payment credentials in contactless fashion, for example from a mobile device according to the EMV Contactless Specification, or from a mobile device in a contactless magnetic stripe transaction by magnetic secure transmission (MST) technology. The transaction request message can be an ISO 8583 formatted message when the transaction request message is an EMV transaction request message or is encoded in track data when the transaction request message is a contactless magnetic stripe transaction request message.

At step 650, the payment system then initiates payment authorization upon receiving the transaction request message and a positive verification of the at least one template from the biometric authentication system. In one example, the POS device sends the user account information and payment information to the merchant's acquirer server. The acquirer server then requests that the card network obtain an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

At step 680, the POS device determines whether payment was completed, and if not the process ends at step 685. Otherwise, an indication that the transaction was successful will be provided to the POS device from the issuer or acquirer. The POS device then displays a transaction complete notification to be displayed at step 690.

User At Remote Location

In an instance when the user is at a remote location, at step 630, the user payment device then sends a transaction request message including the user account information to the payment system. If the user has been prompted to supply account information via a payment page or the like displayed on the user payment device, the user can manually enter bank account or card details in the payment UI.

Whilst any type of wallet application may be used, such as MasterPass™, Apple™ Pay, Google™ Wallet, or the like, in some instances the application is provided by a user's banking institution. Payment credentials (such as a primary account number (PAN) or a token representative of a PAN) from the user payment device are transmitted together with other transaction-related information, to a payment system for processing. The transaction request message can be an ISO 8583 formatted message when the transaction request message is an EMV transaction request message or can be encoded in track data when the transaction request message is a contactless magnetic stripe transaction request message.

The payment system then initiates payment authorization at step 875 upon receiving the transaction request message and a positive verification of the at least one template from the biometric authentication system. In one example, the user payment device sends the user account information and payment information to the merchant's acquirer server. The acquirer server then requests that the card network obtain an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

At step 880, the user payment device determines whether payment was completed, and if not the process ends at step 885. Otherwise, an indication that the transaction was successful will be provided to the user payment device from the issuer or acquirer. The user payment device then displays a transaction complete notification to be displayed at step 890.

Embodiments of the present invention provide users with a convenient way to utilise secondary user biometric data for user authentication. It is advantageous that an additional level of authentication can be provided without additional effort/intervention from the user. Furthermore, at least some embodiments of the present invention can be carried out without any substantial modification to the hardware of existing user payment devices and the use of the secondary user biometric data can also aid in fraud detection/prevention. This may help to reduce network traffic since there is a reduced rate of additional authorization requests required following fraud detection.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

We claim:

1. A system for utilizing secondary user biometric data for user authorization, the system including one or more electronic devices that:
initiate, at a user payment device, a transaction request using primary user biometric information;
activate, at the user payment device, at least one sensor to capture secondary user biometric information;
generate, at the user payment device, at least one template from the secondary user biometric information;
transmit, to a biometric authorization system, the at least one template for verification;
request, from the user payment device and/or a payment acceptance device, user account information;
generate, from the user payment device or payment acceptance device, a transaction request message including the user account information; and
initiate, at a payment processing system, a payment authorization request using the transaction request message and a positive verification of the at least one template.

2. The system of claim 1, wherein the payment acceptance device is a point-of-sale (POS) terminal.

3. The system of claim 1, wherein the primary and the secondary user biometric information are obtained from the user payment device.

4. The system of claim 3, wherein the primary user biometric information is verified at one or more of: the user payment device, and the biometric authorization system.

5. The system of claim 4, wherein the secondary user biometric information is verified at the biometric authorization system.

6. The system of claim 1, wherein the primary and secondary user biometric information comprises one or more selected from the group consisting of: fingerprint data, iris data, facial features data, pulse rate data, voice data, retina data, ear cavity echo data, vein pattern data and speech pattern data.

7. The system of claim 1, wherein the transaction request message is an ISO 8583 formatted message, the transaction request message being either an EMV transaction request message or being encoded in track data when the transaction request message is a contactless magnetic stripe transaction request message.

8. The system of claim 1, the system including one or more electronic devices that: determine, at the user payment device, if a transaction amount is more than a predefined amount.

9. The system of claim 1, the system including one or more electronic devices that: activate, at the user payment device, at least one sensor to recapture the primary user biometric information.

10. The system of claim 1, wherein the biometric authorization system is either an issuer server or a third party verification server.

11. A method for utilizing secondary user biometric data for user authentication, the method including, in one or more electronic processing devices:
initiating, at a user payment device, a transaction request using primary user biometric information;
activating, at the user payment device, at least one sensor to capture secondary user biometric information;
generating, at the user payment device, at least one template from the secondary user biometric information;
transmitting, to a biometric authorization system, the at least one template for verification;
requesting, from the user payment device and/or a payment acceptance device, user account information;
generating, from the user payment device or payment acceptance device, a transaction request message including the user account information; and
initiating, at a payment processing system, a payment authorization request using the transaction request message and a positive verification of the at least one template.

12. The method of claim 11, wherein the payment acceptance device is a point-of-sale (POS) terminal.

13. The method of claim 11, wherein the primary and the secondary user biometric information are obtained from the user payment device.

14. The method of claim 13, wherein the primary user biometric information is verified at one or more of: the user payment device, and the biometric authorization system.

15. The method of claim 14, wherein the secondary user biometric information is verified at the biometric authorization system.

16. The method of claim 11, wherein the primary and secondary user biometric information comprises one or more selected from the group consisting of: fingerprint data, iris data, facial features data, pulse rate data, voice data, retina data, ear cavity echo data, vein pattern data and speech pattern data.

17. The method of claim 11, wherein the transaction request message is an ISO 8583 formatted message, the transaction request message being either an EMV transaction request message or being encoded in track data when the transaction request message is a contactless magnetic stripe transaction request message.

18. The method of claim 11, further including, in one or more electronic processing devices:
determining, at the user payment device, if a transaction amount is more than a predefined amount.

19. The method of claim 11, further including, in one or more electronic devices: activating, at the user payment device, at least one sensor to recapture the primary user biometric information.

20. The method of claim 11, wherein the biometric authorization system is either an issuer server or a third party verification server.

21. A user payment device for utilizing secondary user biometric data for user authentication, the device including one or more electronic devices that:
initiate, a transaction request using a primary user biometric information;
activate, at least one sensor to capture secondary user biometric information;
generate, at least one template extracted from the secondary user biometric information;
transmit, to a biometric authorization system, the at least one template for verification;
provide, user account information; and
generate, a transaction request message including the user account information and the user biometric information.

22. A non-transitory computer readable storage medium embodying thereon a program of computer readable instructions which, when executed by one or more processors of a user payment device in communication with at least one other server, cause the user payment device to carry out a method for utilizing secondary user biometric data for user authentication, the method embodying the steps of:
initiating, a transaction request using a primary user biometric information;
activating, at least one sensor to capture secondary user biometric information;
generating, at least one template extracted from the secondary user biometric information;
transmitting, to a biometric authorization system, the at least one template for verification;
providing, user account information; and
generating, a transaction request message including the user account information.
